(19) United States
(12) Patent Application Publication
(10) Pub. No.: US 2005/0048929 A1
(43) Pub. Date: Mar. 3, 2005

(54) Communications system

(75) Inventor: Kenichi Ogino, Toyota-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/901,070

(22) Filed: Jul. 29, 2004

(30) Foreign Application Priority Data
Sep. 2, 2003 (JP) 2003-310573

(51) Int. Cl. H04B 1/06

(52) U.S. Cl. 455/90.1; 455/575.9; 455/345

(57) ABSTRACT

When communications is established between a sender and recipient, elapsed times of reception waiting timers are reset in the sender and recipient at timings, respectively, as follows: for the sender, at a timing when the sender receives a reply to a command that the sender sent; and for the recipient, at a timing when the recipient sends a reply to the command that the recipient received. Of the sender and recipient, the elapsed times of the reception waiting timers, and furthermore settings of operation modes thereby accord with each other. On the other hand, when the communications is not established because of a blank shooting or the like, the reply is neither sent nor received by the recipient or sender, respectively. The reception waiting timers are thereby not reset; therefore, no difference occurs in the elapsed time between the sender and recipient.

### CROSS REFERENCE TO RELATED APPLICATIONS

This application is based on and incorporates herein by reference Japanese Patent Application No. 2003-310573 filed on Sep. 2, 2003.

### FIELD OF THE INVENTION

The present invention relates to a communications system that is used in a portable device and an in-vehicle device in a key-less entry system using bi-directional wireless communications.

### BACKGROUND OF THE INVENTION

Conventionally, a key-less entry system where a state of a vehicular door is remotely operated by manipulating a portable device (electronic key) a user carries is known. In this key-less system, when a user manipulates a button of the portable device, the portable device sends a wireless signal as an activation command signal that commands locking or unlocking of a door. Upon receiving the wireless signal from the portable device, the in-vehicle device (an electronic control device provided in a vehicle) causes an actuator for door lock to execute locking or unlocking of the door. Here, the wireless signal includes identification information such as a password unique to the portable device, so that the in-vehicle device causes the actuator to operate only when the password corresponds to a registered one.

In this key-less system, the in-vehicle device is powered by a battery, so that the battery may run out when a reception circuit of the in-vehicle device is being continuously turned on for continuously waiting for signals from the portable device. Therefore, the reception circuit is intermittently turned on under a reception waiting state, so that the consumption power in the reception circuit can be decreased.

In this structure where the reception circuit of the in-vehicle device is intermittently activated, the portable device sends an activation command signal along with an additional wake-up signal that is longer than an intermittent cycle. Namely, upon waking up from a sleep state, the reception circuit of the in-vehicle device tries to detect the wake-up signal. When the wake-up signal is not detected, the reception circuit returns to the sleep state. By contrast, when the wake-up signal is detected, the reception circuit receives the activation command signal following the wake-up signal.

Further, to decrease the consumption power in the reception circuit, a time length of the intermittent cycle or wake-up signal is varied according to the elapsed time from the communications that is finally established (for instance, in JP-H10-336760 A). Here, both of the portable device and in-vehicle device have timers that log elapsed times. The portable device resets its timer by determining establishment of the communications when a manipulation to a button is detected, while the in-vehicle device resets its timer by determining establishment of the communications when a signal from the portable device is received. The elapsed times from the communications that are finally established are thereby indicated by the timers and used for controlling. As the logged elapsed time increases, the time length of the intermittent cycle or wake-up signal is increased in stages.

Incidentally, there is a blank shooting that occurs when a manipulation to a button of the portable device is performed outside the communications area of the in-vehicle device because of a mis-manipulation by a user. The blank shooting also may occur under a condition where the portable device disposed within a pocket or bag contacts with another object. When the blank shooting takes place in the key-less entry system that varies the intermittent cycle according to the elapsed time, only the timer in the portable device is reset. This results in the intermittent cycle of the in-vehicle device that becomes longer than the wake-up signal from the portable device. Detecting of the wake-up signal by the in-vehicle device or further receiving the activation command signal may thereby become impossible depending on the timing of the manipulation to a button. As a result, the system cannot be activated unless the manipulation to a button in the portable device is repeated many times, which worsens the operationality.

Further, in recent years, a single portable device such as an electronic key is expected to control not only the door lock but also immobilizer, steering lock, and the like, by being constructed to perform a bidirectional communications with a corresponding in-vehicle device. Here, the portable device not only one-directionally sends a command to the in-vehicle device, but also needs to receive a command from the in-vehicle device, so that the portable device needs to perform intermittent operation under a reception waiting state like the above in-vehicle device does. Since the portable device generally uses a button battery or the like, saving the power consumption is required more compared to the in-vehicle device. Furthermore, when the blank shooting takes place in the portable device, another problem occurs where the power consumption is increased because of shortening the intermittent cycle in addition to the above-described problem.

### SUMMARY OF THE INVENTION

It is an object of the present invention to provide a communications system that prevents a deviation of synchronization due to blank shooting or the like, securely communicates at timing of user's manipulation, and further decreases power consumption under a reception waiting state.

To achieve the above object, a communications system used in a portable device and an in-vehicle device in a key-less entry system using bi-directional wireless communications and intermittent cycles in a reception waiting state is provided with the following. Two processes are included, namely, a transmission process that is started based on a transmission request and a reception process that is started when a wake-up signal is detected. In the transmission process, a signal generated based on the transmission request is transmitted by a sender while being accompanied by a wake-up signal whose time length is based on the intermittent cycle. In the reception process, the wake-up signal and the signal accompanied by the wake-up signal are received and then a reply is returned by a recipient. A timer is provided to log an elapsed time. A first intermittent cycle setting unit is provided to variably set the intermittent cycle based on the elapsed time. A timing adjusting unit is further provided to reset the elapsed time when a communications between the sender and the recipient is established.

Namely, the elapsed time logged by the timer can be reset only when the communication between the sender and recipient is established, instead of when the transmission request is received. Therefore, the deviation of the synchronization can be prevented. Further, a single transmission request can securely establish a communications and also prevent useless increase of power consumption under the reception waiting state.

### BRIEF DESCRIPTION OF THE DRAWINGS

The above and other objects, features, and advantages of the present invention will become more apparent from the following detailed description made with reference to the accompanying drawings. In the drawings:

FIG. 1 is a schematic block diagram of a structure of a key-less entry system according to a first embodiment;

FIG. 2 is a flow chart diagram showing a command transmission process executed by a control unit;

FIG. 3 is a flow chart diagram showing a command reception process executed by a control unit;

FIG. 4 is a flow chart diagram showing an operation mode setting process executed in a command reception process;

FIGS. 5A, 5B are time chart diagrams showing schematic communications performed in a portable device and in-vehicle device;

FIG. 6A is a flow chart diagram showing an operation mode setting process according to a second embodiment; and

FIG. 6B is a diagram showing a determination table used to determine operation modes with respect to time zones.

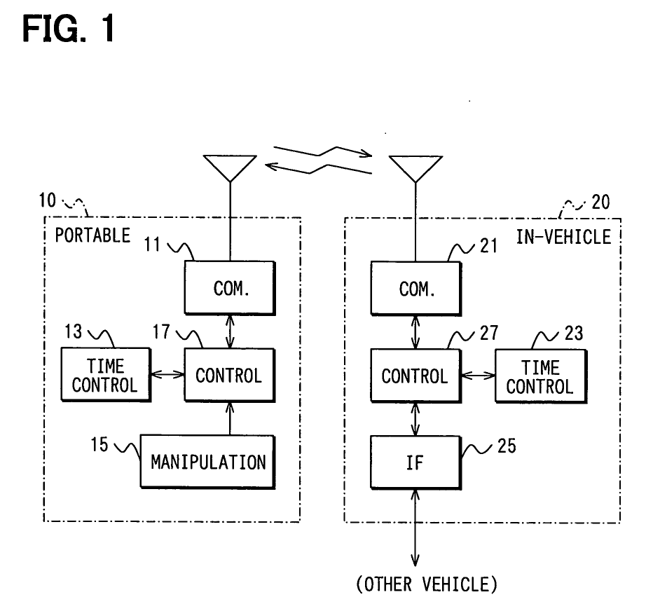

### DETAILED DESCRIPTION OF THE PREFERRED EMBODIMENTS

### First Embodiment

The present invention is directed to a key-less entry system of a first embodiment. The key-less entry system includes a portable device 10 that a user carries and an in-vehicle device 20 that is mounted on a vehicle to communicate with the portable device 10.

The portable device 10 includes as follows: a communications unit 11; a time control unit 13; a manipulation/notification unit 15; and a control unit 17. The communications unit 11 is for sending and receiving wireless signals. The time control unit 13 includes a reception waiting timer that logs elapsed time from communications that is finally properly executed. The manipulation/notification unit 15 includes a manipulation button for commanding transmission of various commands, and a device (speaker, liquid crystal display, vibrator, or the like) for indicating the command from the in-vehicle device 20 using at least one of an acoustic sense, tactile sense, and visual sense.

The control unit 17 is formed of a known micro-computer including a CPU, ROM, and RAM and, executes various processes such as a command transmission process, a command reception process, and an operation mode setting process. In the command transmission process, a code signal is generated to correspond to a command designated from manipulation in the manipulation/notification unit 15; then, a transmission signal including the code signal is sent via the communications unit 11 to the in-vehicle device 20. In the command reception process, a code signal included in a reception signal received from the in-vehicle device 20 via the communications unit 11 is analyzed, and a given operation to accord with a command designated by a result of analyzing (such as causing a liquid crystal panel of the manipulation/notification unit 15 to display a message) is executed. In the operation mode setting process, an operation mode under a reception waiting state is set according to the elapsed time logged by the reception waiting timer.

The in-vehicle device 20 includes as follows: a communications unit 21 and a time control unit 23, which are constructed similarly with the communications unit 11 and time control unit 13 in the portable device 10; an interface (IF) unit 25; and a control unit 27. The interface unit 25 is for communicating with other in-vehicle devices via an in-vehicle LAN.

The control unit 27 is formed of a known micro-computer including a CPU, ROM, and RAM and executes various processes such as a command transmission process, a command reception process, and an operation mode setting process. In the command transmission process, a code signal corresponding to a transmission request inputted from other in-vehicle devices via the interface unit 25 is generated; then, a transmission signal including the code signal is sent via the communications unit 21 to the portable device 10. In the command reception process, a code signal included in a reception signal received via the communications unit 21 from the portable device 10 is analyzed, and a given operation to accord with a command designated by a result of analyzing (such as locking or unlocking a door) is executed. In the operation mode setting process, an operation mode under a reception waiting state is set according to the elapsed time logged by the reception waiting timer.

Here, the operation mode set by the control units 17, 27 includes three modes of a normal mode MO, a first power saving mode Ml, and a second power saving mode M2. The time control units 13 controls, according to the operation mode set, power supply to the communications unit 11 and control unit 17 under the reception waiting state. By contrast, the time control units 23 controls, according to the operation mode set, power supply to the communications unit 21 and control unit 27 under the reception waiting state. Intermittent operations are thereby performed in the portable device 10 and in-vehicle device 20, respectively.

Here, in the normal mode M0, a repeating cycle for intermittent operation (hereinafter referred to as “intermittent cycle”) is set to W0 (200 ms in this embodiment). In the first power saving mode M1, the intermittent cycle is set to W1 (>W0) (800 ms in this embodiment). In the second power saving mode M2, the intermittent cycle is set to W2 (>W1) (1400 ms in this embodiment).

When the manipulation button of the manipulation/notification unit 15 in the portable device 10 is manipulated, the communications unit 11 and control unit 17 of the portable device 10 are switched into an operation state. By contrast, when a transmission request is received from other in-vehicle devices by the interface unit 25 of the in-vehicle device 20, the communications unit 21 and control unit 27 of the in-vehicle device 20 are switched into an operation state.

Further, the communications units 11, 21 send code signals generated by the control units 17, 27 along with wake-up signals that are added to the front of the code signals when sending the code signals, respectively. When the wake-up signals are detected while the operation state, the code signals following the wake-up signals are received and provided to the control units 17, 27, respectively. Here, the wake-up signals are longer than the intermittent cycles of the operation modes set.

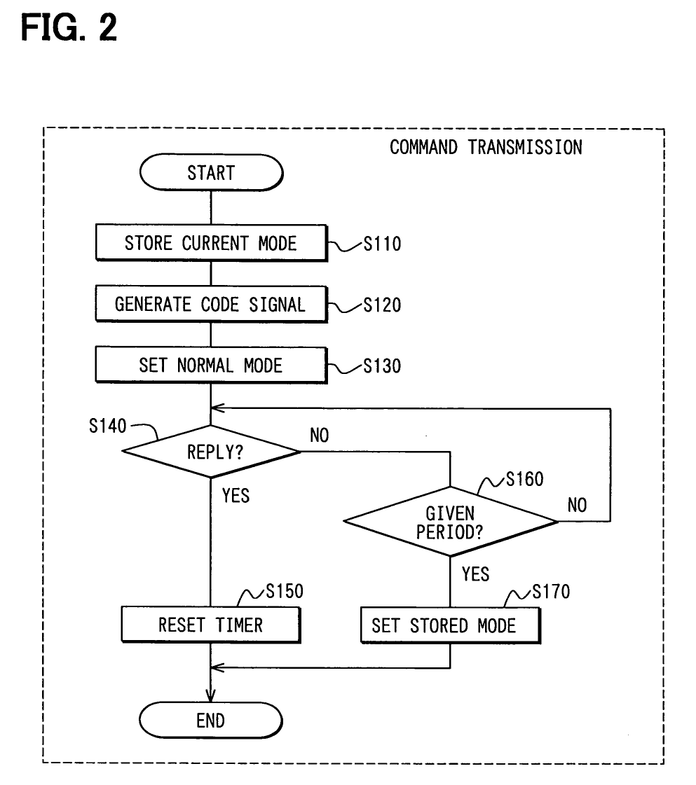

Processes executed by the control unit 17 of the portable device 10 will be explained below. In the first place, a command transmission process will be explained with reference to a flow chart in FIG. 2. This command transmission process is activated when the manipulation button is manipulated in the manipulation/notification unit 15.

When this process is started, an operation mode that is currently set is stored (S110). A code signal corresponding to a command that is assigned to the manipulation button manipulated is generated and provided to the communications unit 11 (S120). The communications unit 11 sends the code signal provided along with a wake-up signal that has a time length corresponding to the operation mode currently set.

Thereafter, the operation mode is set to M0 (S130), so that the control unit 17 moves into a reception waiting state where a reply from the in-vehicle device 20 is awaited. This causes the portable device 10 to switch to an operation state so as to determine whether the reply is received or not (S140). The determination that the reply is received means that the communications unit 11 detects a wake-up signal, then receives a code signal following the wake-up signal detected, and provides the code signal received to the control unit 17. When the reply from the in-vehicle device 20 is determined to be received, the communications with the in-vehicle device 20 is determined to be established (S140: YES). The elapsed time of a logged value of the reception waiting timer is thereby reset (S150). The process is then terminated.

By contrast, when the reply from the in-vehicle device 20 is determined to be not received (S140: NO), it is determined whether a given reply waiting period that is at least longer than the intermittent cycle W0 (1000 ms in this embodiment) passes (S160). When the given reply waiting period does not pass, the process returns to S140.

When the given reply waiting period passes without receiving the reply from the in-vehicle device 20, the operation mode is switched to the operation mode that is previously stored at S110 (S170). The process is then terminated.

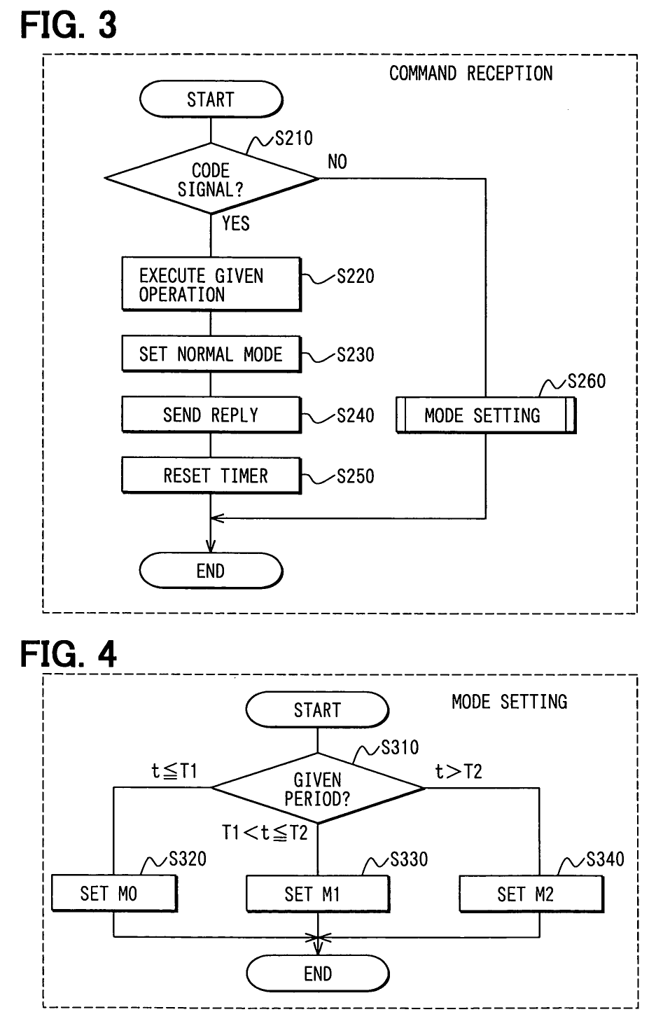

Next, a command reception process will be explained below with reference to FIG. 3. This command reception process is started each time the power is turned on by the intermittent operation, only for a period other than the given reply waiting period that takes place just after the command transmission process. Simultaneously this process is started, the communications unit 11 is activated to try to detect a wake-up signal. When the wake-up code is detected, the communications unit 11 then receives a code signal following the wake-up signal detected, and provides the code signal received to the control unit 17.

In the command reception process, it is determined whether a code signal from the communications unit 11 is provided (S210). When the code signal is provided, the code signal is analyzed; then a given operation takes place according to a command designated by the code signal analyzed (S220).

The operation mode is then set to a normal mode (S230). A code signal indicating a reply is generated and provided to the communications unit 11, so that the reply is returned to the in-vehicle device 20 (S240). Here, the communications unit 11 adds, to the code signal provided, a wake-up signal that is longer than an intermittent cycle WO of the operation mode that is currently set (namely, a normal mode MO), then sending the code signal along with the wake-up signal. The elapsed time of the logged value of the reception waiting timer is thereby reset (S250). The process is then terminated.

By contrast, when the code signal from the communications unit 11 is not provided (S210: NO), an operation mode setting process is executed based on the elapsed time logged by the reception waiting timer (S260). The process is then terminated.

The operation mode setting process executed at S260 will be explained with reference to FIG. 4. When this process is started, the elapsed time t logged by the reception waiting timer is compared with a first threshold value T1 that is previously set (7 days in this embodiment) and a second threshold value T2 that is previously set (30 days in this embodiment) (S310).

When the elapsed time t is not more than 7 days (t≦T1), the operation mode is set to a normal operation mode M0. When the elapsed time t is more than 7 days and not more than 30 days (T1<t≦T2), the operation mode is set to a first power saving mode M1. When the elapsed time t is more than 30 days (T2<t), the operation mode is set to a second power saving mode M2. The process is then terminated.

Processes of the control unit 27 of the in-vehicle device 20 are similar with those of the control unit 17 of the portable device 10, so that explanation is removed. However, to understand the processes of the control unit 27, the above corresponding explanation must be read by replacing the portable device 10 by the in-vehicle device 20; by replacing the in-vehicle device 20 by the portable device 10; and further by replacing the communications unit 11, time control unit 13, manipulation/notification unit 15, or control unit 17 by the communications unit 21, time control unit 23, interface unit 25, or control unit 27, respectively.

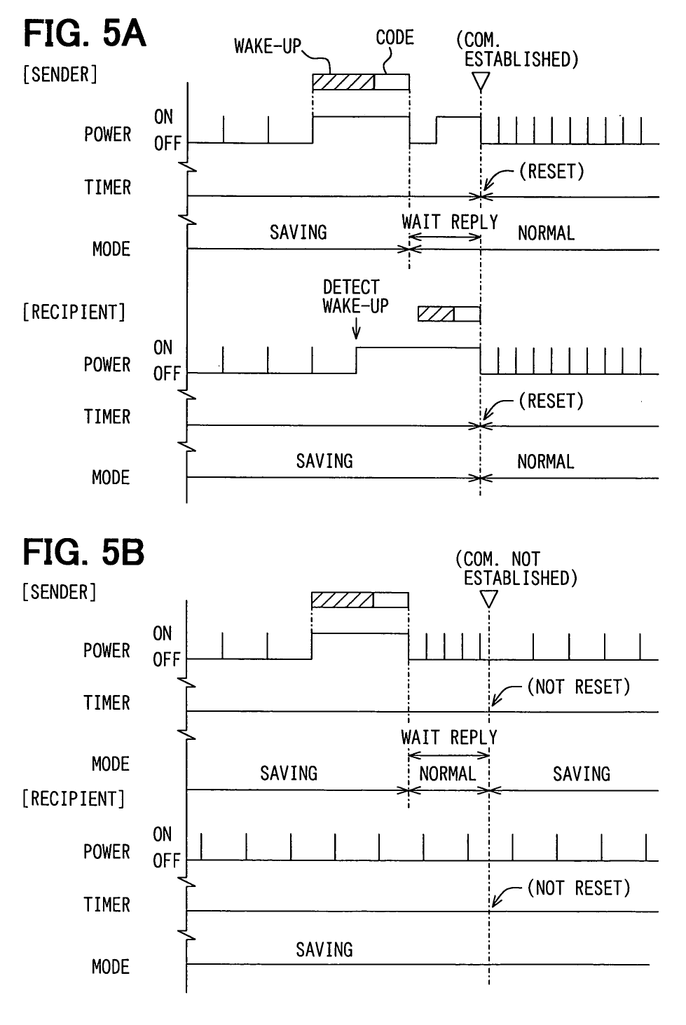

In this key-less entry system of this embodiment, as shown in FIG. 5A, after a sender that sends a code signal (hereinafter referred to “command”) indicating a command sends the command along with a wake-up signal, the sender waits for a code signal (hereinafter referred to as “reply”) indicating a reply in a normal mode. When the sender thereafter receives the reply, the elapsed time of the reception waiting timer is reset and continues the normal mode. Here, when a recipient detects the wake-up signal and receives the command, the recipient returns the reply and then resets the elapsed time of its own reception waiting timer to then start a normal mode.

By contrast, when the recipient cannot receive the command, the sender does not receive the reply, as shown in FIG. 5B. After a given reply waiting period passes, the sender thereby determines that the communications with the recipient is not established, and returns the normal operation mode to the operation mode that was used before the command is sent, without resetting the elapsed time of its reception waiting timer.

Here, the recipient operates at an operation mode corresponding to the elapsed time while the elapsed time being not reset. Namely, when the communications between the sender and recipient is established, both of the sender and recipient reset the elapsed times of their reception waiting timers at timings that are approximately equivalent to a timing when the reply is sent and received. The elapsed times of the reception waiting timers of the sender and recipient thereby substantially accord with each other, which enables the operation modes of the both to be the same.

By contrast, when the communications is not established due to blank shooting or the like, the reply is neither sent nor received. Therefore, the both do not reset the elapsed times of their reception waiting timers, so that logging of the elapsed times are continued in the both. This prevents significant difference in elapsed time between the sender and recipient.

As explained above, in the key-less system of this embodiment, the operation modes of the portable device 10 and in-vehicle device 20 are set based on the elapsed times that start from when the communications therebetween is properly established. Namely, as the elapsed time increases, a time length of an intermittent cycle for the intermittent operation under the reception waiting state is increased. Consequently, when a period for no use of the portable device 10 and in-vehicle device 20 is extended, power consumption can be decreased due to the intermittent operation.

A sender that sends a command determines that communications with a communications counterpart is properly performed when the sender receives a reply to the command, while a recipient that receives the command determines that communications with a communications counterpart is properly performed when the recipient sends the reply. By the above two determinations, the elapsed times of their reception waiting timers are reset, which prevents that only either of the sender or recipient resets the corresponding elapsed time. The portable device 10 and in-vehicle device 20 can be thereby securely operated at the same operation mode.

As a result, each of the portable device 10 and in-vehicle device 20 can securely detect a wake-up signal sent from a communications counterpart. For example, when the manipulation button is manipulated, only a single manipulation enables the command corresponding to the manipulation to be securely conveyed to the in-vehicle device 20, providing comfortable operationality.

Further, a sender that sends a command operates in a normal operation mode M0 regardless of the elapsed time for a given reply waiting period just after the command is sent, while a recipient that receives the command adds a wake-up signal corresponding to the normal operation mode M0 when a reply to the command is sent. Consequently, a period required for receiving a reply, or consumption power can be suppressed to a necessary minimum level.

### Second Embodiment

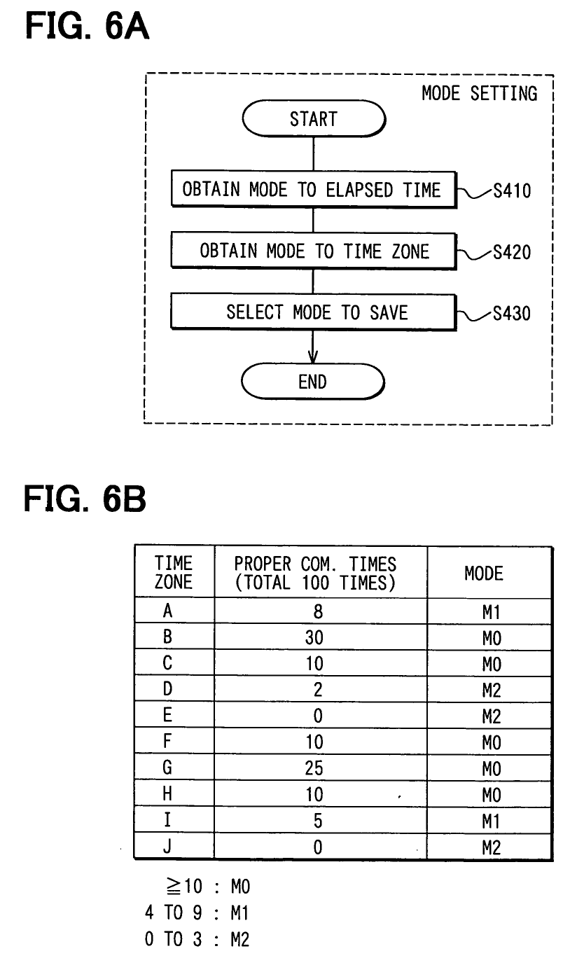

A second embodiment has different portions from the first embodiment in part of processes of the control units 17, 27, so that the different portions will be mainly explained below with reference to FIGS. 6A, 6B. FIG. 6A shows a flow chart of an operation mode setting process, while FIG. 6B shows a determination table stored in memories (nonvolatile RAM) formed within the control units 17, 27 for determining operation modes.

The determination table includes a communications frequency and an operation mode that is to be selected, with respect to each time zone A to J that is previously designated, as shown in FIG. 6B. The communications frequency is a frequency (times) the communications is properly performed with respect to each of time zones. For example, eight communications are properly performed in a time zone A, while 30 communications are properly performed in a time zone B.

The operation mode to be selected with respect to each time zone is determined based on threshold values C1, C2 (C1: three times, C2: nine times, in this embodiment). In detail, when the communications frequency N is not more than C1 (N≦C1), the second power saving mode M2 is designated; when the communications frequency N is more than C1 and not more than C2 (C1<N ≦C2), the first power saving mode M1 is designated; and when the communications frequency N is more than C2 (C2<N), the normal mode M0 is designated.

In this embodiment, an updating process for the determination table takes place along with resetting of the elapsed times of the reception waiting timers at S150 in the command transmission process shown in FIG. 2 and at S250 in the command reception process shown in FIG. 3.

In this updating process for the determination table, a current time is obtained initially, and a communications frequency in a time zone corresponding to the current time is incremented (+1) while a communication frequency in a time zone corresponding to the oldest datum among the 100 data included in the determination table is decremented (−1).

Each of the updated communications frequencies is compared with the threshold values C1, C2. When an operation mode needs updating, the operating mode is changed.

Further, at S260 in the command reception process in FIG.3, an operating mode setting process shown in FIG. 6A is executed. When this process is started, an operating mode is obtained based on an elapsed time logged by the reception waiting timer (S410). In detail, the operating mode is set by the operating mode setting process shown in FIG. 4.

Next, a current time is obtained. An operating mode designated based on a time zone including the current time obtained and the determination table is then obtained (S420). The operating modes obtained at S410, S420 are compared with each other to set, as a practical operating mode, either of the operating modes that consumes less power (S430). The process is then terminated.

For example, it is supposed that no communications takes place between the portable device 10 and in-vehicle device 20 not less than seven days. Here, with respect to the time zone B that is frequently used, the first saving mode M1 is designated based on the elapsed time, while the normal mode M0 is designated based on the time zone. The saving mode M1 is eventually selected due to its effect consuming less power.

As explained above, in this embodiment, an operating mode that consumes less power is practically used by being selected from among the operating mode designated based on the elapsed time starting from when the communications is finally established and the operating mode designated based on a time zone including the current time. This second embodiment thereby not only exhibits the same effect as the first embodiment does, but also further decreases the consumption power in the portable device 10 and in-vehicle device 20 when there are a great deal of frequency difference among the time zones when the communications are executed.

Further, the determination table is produced by using the past 100 time data, so that the determination table can promptly follow a change such that a user is changed or a life style of a user is changed.

Further, the determination table is produced by using a limited number of data (past 100 times in the second embodiment); however, it can be produced by using the entire past data. Further, the time zones can be classified within a day (24 hours) or within a week or month.

It will be obvious to those skilled in the art that various changes may be made in the above-described embodiments of the present invention. However, the scope of the present invention should be determined by the following claims.

1. A communications system used in a portable device and an in-vehicle device in a key-less entry system using bidirectional wireless communications, wherein a power source of the communications system is intermittently turned on according to an intermittent cycle under a reception waiting state, the communications system including at least a transmission process that is started based on a transmission request and a reception process that is started when the power source is intermittently turned on,
wherein, in the transmission process, a signal generated based on the transmission request is transmitted by a sender while being accompanied by a wake-up signal whose time length is based on the intermittent cycle,
wherein, in the reception process, when the wake-up signal is detected, the wake-up signal and the signal accompanied by the wake-up signal are received and then a reply is returned by a recipient,
the communications system comprising:
a timer that logs an elapsed time;
a first intermittent cycle setting unit that variably sets the intermittent cycle based on the elapsed time logged by the timer; and
a timing adjusting unit that resets the elapsed time logged by the timer when a communications between the sender and the recipient is established.

2. The communications system of claim 1,
wherein the timing adjusting unit determines that the communications is established in the sender when the reply is received from the recipient, while the timing adjusting unit determines that the communications is established in the recipient when the reply is returned.

3. The communications system of claim 1,
wherein, after the signal is transmitted in the transmission process, the intermittent cycle is set to a shortest time length within time lengths that are able to be set until the reply is received or until a given period for awaiting the reply passes.

4. The communications system of claim 1, further comprising:
a time obtaining unit that obtains a current time;
a second intermittent cycle setting unit that sets an intermittent cycle according to, of a plurality of time zones, a time zone that includes the current time obtained by the time obtaining unit;
a selecting unit that selects one of the intermittent cycle set by the first intermittent cycle setting unit and the intermittent cycle set by the second intermittent cycle setting unit so that a lower power consumption is achieved when the intermittent cycle set by the first intermittent cycle setting unit and the intermittent cycle set by the second intermittent cycle setting unit are different from each other.

5. The communications system of claim 4, further comprising:
a learning unit that counts a frequency the communications between the sender and recipient is established with respect to each of the plurality of time zones, wherein the intermittent cycle set by the second intermittent cycle setting unit is set based on the frequency counted, with respect to the each of the plurality of time zones.
